(19) United States
(12) Patent Application Publication
(10) Pub. No.: US 2023/0002281 A1
(43) Pub. Date: Jan. 5, 2023

(54) HIGH-SILICA-CONTAINING SUPPLEMENTARY CEMENTITIOUS MATERIALS, AND METHOD OF PRODUCING SAME

(71) Applicant: Solidia Technologies, Inc., Piscataway, NJ (US)

(72) Inventors: Sadananda Sahu, Tallahassee, FL (US); Vahit Atakan, West Windsor, NJ (US); Nicholas DeCristofaro, Chatham, NJ (US)

(21) Appl. No.: 17/854,778

(22) Filed: Jun. 30, 2022

Related U.S. Application Data
(60) Provisional application No. 63/217,574, filed on Jul. 1, 2021.

(51) Int. Cl. C04B 20/10; C04B 7/02; C04B 20/12

(52) U.S. Cl. CPC C04B 20/1074; C04B 7/02; C04B 20/1077; C04B 20/123

(57) ABSTRACT

A high-silica-containing supplemental cementitious materials, and a method of producing same. This material undergoes a pozzolanic reaction during hydration in a mixture of Ordinary Portland Cement (OPC) or lime.

### CROSS-REFERENCE TO RELATED APPLICATION

This application claims the benefit of priority pursuant to 35 U.S.C. § 119(e) to U.S. provisional Application No. 63/217,574, filed Jul. 1, 2021, the entire contents of which are incorporated by reference as if fully set forth herein.

### FIELD

The present application is directed to a high-silica-containing supplemental cementitious materials, and a method of producing same.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The production of ordinary Portland cement (OPC) is a very energy-intensive process and a major contributor to greenhouse gas emissions. The cement sector is the third largest industrial energy consumer and the second largest CO₂ emitter of total industrial CO₂ emissions. World cement production reached 4.1 Gt in 2019 and is estimated to contribute about 8% of total anthropogenic CO₂ emissions.

In an attempt to combat climate change, the members of the United Nations Framework Convention on Climate Change (UNFCC), through the Paris Agreement adopted in December 2015, agreed to reduce CO₂ emissions by 20% to 25% in 2030. This represents an annual reduction of 1 giga ton CO₂. Under this agreement, the UNFCC agreed to keep the global temperature rise within 2° C. by the end of this century. To achieve this goal, the World Business Council for Sustainable Development (WBCSD) Cement Sustainability Initiative (CSI) developed a roadmap called “Low-Carbon Transition in Cement Industry” (WBCSD-CSI). This roadmap identified four carbon emissions reduction levers for the global cement industry. The first lever is improving energy efficiency by retrofitting existing facilities to improve energy performance. The second is switching to alternative fuels that are less carbon intensive. For example, biomass and waste materials can be used in cement kilns to offset the consumption of carbon-intensive fossil fuels. Third is reduction of clinker factor or the clinker to cement ratio. Lastly, the WBCSD-CSI suggests using emerging and innovative technologies such as integrating carbon capture into the cement manufacturing process.

Thus, there is a need for improved cement production that reduces CO₂ emissions; and, therefore, reduces the global effect of climate change. The present disclosure attempts to address these problems, as identified by the EPA and the UNFCCC, by developing a method of integrating carbon capture into the cement manufacturing process.

For instance, Solidia Technologies Inc. has developed a low CO₂ emissions clinker that reduces CO₂ emissions by 30%. However, a need exists to integrate such materials into conventional hydraulic concrete materials in order to reduce the clinker factor in hydraulic cements such as ordinary Portland cement (OPC), and to further boost the positive environmental potential through the use of such low CO₂ emissions materials as supplementary cementitious materials (SCM) in concrete. While certain aspects of conventional technologies have been discussed to facilitate disclosure of the invention, Applicant in no way disclaims these technical aspects, and it is contemplated that the claimed invention may encompass or include one or more of the conventional technical aspects discussed herein.

### SUMMARY

It has been discovered that the above-noted deficiencies can be addressed, and certain advantages attained, by the present invention. For example, the methods, and compositions of the present invention provide a novel approach to pre-carbonate a carbonatable clinker, preferably but not exclusively a low CO₂ emission clinker, before adding it to a hydraulic cement as a supplementary cementitious material (SCM), thereby both reducing the clinker factor of conventional hydraulic cements, and incorporating carbon capture into the production of the cement or concrete material, thus providing a doubly positive environmental benefit.

It should be understood that the various individual aspects and features of the present invention described herein can be combined with any one or more individual aspect or feature, in any number, to form embodiments of the present invention that are specifically contemplated and encompassed by the present invention. Furthermore, any of the features recited in the claims can be combined with any of the other features recited in the claims, in any number or in any combination thereof. Such combinations are also expressly contemplated as being encompassed by the present invention.

According to an exemplary embodiment, the present invention provides a method for forming cement or concrete, including: combining a carbonated supplementary cementitious material with a hydraulic cement composition to form a mixture, wherein the mixture comprises about 1% to about 99%, by weight, of the carbonated supplementary cementitious material, based on the total weight of solids in the mixture; curing the mixture in a Ca(OH)₂ solution; reacting the mixture with water to form the cement or concrete; and wherein the cement or concrete may further include a hydration product selected from Ca(OH)₂ (portlandite), Ca₆Al₂(SO₄)₃(OH)₁₂. 26H₂O (ettringite), Ca₄Al₂(SO₄)(OH)₁₂.6H₂O (monosulfate), 3CaO.Al₂O₃.CaCO₃.11H₂O (monocarbonate), calcium silicate hydrate (C—S—H) gel, and hydrated amorphous mellilites.

According to another exemplary embodiment, the present invention provides cement or concrete including a plurality of bonding elements, each of the bonding elements comprising: a core (uncarbonated cement); a silica-rich first layer at least partially covering a peripheral portion of the core; a calcium carbonate and/or magnesium carbonate-rich second layer at least partially covering a peripheral portion of the first layer; and a layer of C—S—H formed by a reaction of the silica-rich layer with Ca(OH)₂. The silica-rich layer reacts with Ca(OH)₂ produced from ordinary Portland cement (OPC) hydration to form additional C—S—H (pozzolanic reaction), and calcium carbonate from the supplementary cementitious material reacts with OPC to form 3CaO.Al₂O₃.CaCO₃.11H₂O (monocarbonate).

According to another exemplary embodiment, the present invention provides a cementitious material including calcium silicate, calcium carbonate and amorphous silica. The amorphous silica content is present at about 5% to about 50% by mass, and the amorphous silica is reactive with calcium hydroxide to form calcium silicate hydrate gel.

According to another exemplary embodiment, the present invention provides a cementitious material including calcium silicate, calcium carbonate and amorphous silica. The amorphous silica content is present at about 20% to about 40% by mass, and the amorphous silica is reactive with calcium hydroxide to form calcium silicate hydrate gel.

According to another exemplary embodiment, the present invention provides a cement or concrete material including a plurality of bonding elements, wherein each of the bonding elements comprises: a core (uncarbonated cement or concrete); a silica-rich first layer at least partially covering a peripheral portion of the core; a calcium carbonate and/or magnesium carbonate-rich second layer at least partially covering a peripheral portion of the first layer; and a layer of C—S—H formed by a reaction of the silica-rich layer with Ca(OH)₂. The cement or concrete material having such a plurality of bonding elements is prepared from a method comprising: combining a carbonated supplementary cementitious material with a hydraulic cement composition to form a mixture, wherein the mixture comprises about 1% to about 99%, by weight, of the carbonated supplementary cementitious material, based on the total weight of solids in the mixture; curing the mixture in a Ca(OH)₂ solution; and reacting the mixture with water to form the cement or concrete, and the cement or concrete may further include a hydration product selected from Ca(OH)₂ (portlandite), Ca₆Al₂(SO₄)₃(OH)₁₂.26H₂O (ettringite), Ca₄Al₂(SO₄)(OH)₁₂.6H₂O (monosulfate), 3CaO.Al₂O₃.CaCO₃.11H₂O (monocarbonate), calcium silicate hydrate (C—S—H) gel, and hydrated amorphous mellilites.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features of this invention will now be described with reference to the drawings of certain embodiments which are intended to illustrate and not to limit the invention.

FIGS. 1A to 1C are scanning electron microscope (SEM) images of the microstructure of a carbonatable material, according to an exemplary embodiment, with FIG. 1C being an energy dispersive spectrometry (EDS) map showing distribution of melilite phase within the cement particles, according to an exemplary embodiment of this application.

FIGS. 2A to 2G are SEM images of the microstructure of a carbonatable material after carbonation in a slurry, and subsequent drying, according to an exemplary embodiment, with FIGS. 2E, 2F and 2G being EDS maps showing uncarbonated core of the cement particles partially or fully surrounded by silica and calcite layers, and 2E being an EDS map of carbonated cement, according to an exemplary embodiment of this application.

FIGS. 3A to 3G are SEM images of the microstructure of a carbonatable material after carbonation in a slurry, which includes Ca(OH)₂, according to an exemplary embodiment, with FIG. 3D being an EDS map showing distribution of Ca, Si, Fe and Al within the cement particles, FIGS. 3E and 3F being EDS maps showing distribution of Ca, Si and Al within the cement particles, and FIG. 3G being an EDS map showing distribution of K within the cement particles, according to an exemplary embodiment of this application.

FIGS. 4A to 4D are SEM images of the microstructure of a mixture of 20% slurry of carbonatable material and 80% ordinary Portland cement after curing in lime water (Ca(OH)₂) for 28 days, according to an exemplary embodiment, with FIGS. 4C and 4D being EDS maps showing distribution of Ca and Si in the cement particles, according to an exemplary embodiment of this application.

FIGS. 5A to 5E are SEM images of the microstructure of a mixture of 50% slurry of carbonatable material and 50% ordinary Portland cement after curing in lime water (Ca(OH)₂) for 28 days, according to an exemplary embodiment, with FIGS. 5D and 5E being EDS maps showing distribution of Ca and Si in the cement particles, according to an exemplary embodiment of this application.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Unless indicated otherwise, each will of the individual features or embodiments of the present specification are combinable with any other individual feature or embodiment that are described herein, without limitation. Such combinations are specifically contemplated as being within the scope of the present invention, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

As used herein, “semi-wet” is intended to include a state of being partially wet, and “semi-wet material” is intended to include any material that is partially wet, and such a material may include a moisture content in an amount of from about 0.1% to about 99.99%, preferably from about 0.1% to about 50%, and more preferably from about 0.1% to about 20%, and having any values falling within any of these enumerated ranges, such as 0.1%, 1.0%, 0.5% to 10%, 10.5%, 6.75 to 9.25, and the like. The value of the moisture content can be equal to any integer value or values within any of the above-described numerical ranges, including the end-points of the range.

The base material used to form the supplementary cementitious materials of the present invention is not particularly limited so long as it is carbonatable. As used herein, the term “carbonatable” means a material that can react with and sequester carbon dioxide under the conditions described herein, or comparable conditions. The carbonatable material can be a naturally occurring material, or may synthesized from precursor materials.

As used herein, “high-silica” content relates to a material that includes amorphous silica content at about 5% to about 50% by mass, at about 10% to about 45% by mass, at about 15% to about 40% by mass, at about 20% to about 35%, at about 25% to about 30%, at about 27%, and the like. The amorphous silica content can be equal to any integer value or values within any of these ranges, including the end-points of these ranges.

An exemplary embodiment is directed to a method for forming cement or concrete. The method comprises: combining a carbonated supplementary cementitious material with a hydraulic cement composition to form a mixture, wherein the mixture comprises about 1% to about 99%, by weight, of the carbonated supplementary cementitious material, based on the total weight of solids in the mixture; curing the mixture in a Ca(OH)₂ solution; and reacting the mixture with water to form the cement or concrete. The cement or concrete may further include a hydration product selected from Ca(OH)₂ (portlandite), Ca₆Al₂(SO₄)₃(OH)₁₂.26H₂O, Ca₄Al₂(SO₄)(OH)₁₂.6H₂O (monosulfate), (ettringite), 3CaO.Al₂O₃.CaCO₃.11H₂O (monocarbonate), calcium silicate hydrate (C—S—H) gel, and hydrated amorphous mellilites.

The gas comprising carbon dioxide may be flowed in the plurality of carbonation cycles for about 0.01 hours to about 72 hours, for about 0.05 hours to about 70 hours, for about 0.1 hour to about 65 hours, about 0.2 hours to about 60 hours, about 0.3 hours to about 55 hours, about 0.4 hours to about 50 hours, about 0.5 hours to about 45 hours, about 0.6 hours to about 40 hours, about 0.7 hours to about 35 hours, about 0.8 hours to about 30 hours, for about 0.9 hours to about 25 hours, for about 1 hour to about 20 hours, for about 2 hours to about 15 hours, for about 5 hours to about 10 hours, for about 4 hours to about 6 hours, and the like. The time of flowing the gas can be equal to any integer value or values within any of these ranges, including the end-points of these ranges.

The gas comprising carbon dioxide may be flowed over the carbonatable material at a temperature of about 1° C. to about 99° C., about 5° C. to about 90° C., about 10° C. to about 85° C., about 20° C. to about 80° C., about 30° C. to about 70° C., and the like. The temperature can be equal to any integer value or values within any of these ranges, including the end-points of these ranges.

In accordance with exemplary embodiments of the present invention, the carbonatable material can be formed from a first raw material having a first concentration of M is mixed and reacted with a second raw material having a second concentration of Me to form a reaction product that includes at least one synthetic formulation having the general formula MₐMe_{b}O_{c}, MₐMe_{b}(OH)_{d}, MₐMe_{b}O_{c}(OH)_{d} or MₐMe_{b}O_{c}(OH)_{d} (H₂O)ₑ, wherein M is at least one metal that can react to form a carbonate and Me is at least one element that can form an oxide during the carbonation reaction.

As stated, the M in the first raw material may include any metal that can carbonate when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d} (H₂O)ₑ. For example, the M may be any alkaline earth element, preferably calcium and/or magnesium. The first raw material may be any mineral and/or byproduct having a first concentration of M.

As stated, the Me in the second raw material may include any element that can form an oxide by a hydrothermal disproportionation reaction when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d} (H₂O)ₑ. For example, the Me may be silicon, titanium, aluminum, phosphorus, vanadium, tungsten, molybdenum, gallium, manganese, zirconium, germanium, copper, niobium, cobalt, lead, iron, indium, arsenic, sulfur and/or tantalum. In a preferred embodiment, the Me includes silicon. The second raw material may be any one or more minerals and/or byproducts having a second concentration of Me.

In accordance with the exemplary embodiments of the present invention, the first and second concentrations of the first and second raw materials are high enough that the first and second raw materials may be mixed in predetermined ratios to form a desired synthetic formulation having the general formula MₐMe_{b}O_{c}, MₐMe_{b}(OH)_{d}, MₐMe_{b}O_{c}(OH)_{d} or MₐMe_{b}O_{c}(OH)_{d} (H₂O)ₑ, wherein the resulting synthetic formulation can undergo a carbonation reaction. In one or more exemplary embodiments, synthetic formulations having a ratio of a:b between approximately 2.5:1 to approximately 0.167:1 undergo a carbonation reaction. The synthetic formulations can also have an O concentration of c, where c is 3 or greater. In other embodiments, the synthetic formulations may have an OH concentration of d, where d is 1 or greater. In further embodiments, the synthetic formulations may also have a H₂O concentration of e, where e is 0 or greater.

The synthetic formulation reacts with carbon dioxide in a carbonation process, whereby M reacts to form a carbonate phase and the Me reacts to form an oxide phase by hydrothermal disproportionation.

In an example, the M in the first raw material includes a substantial concentration of calcium and the Me in the second raw material contains a substantial concentration of silicon. Thus, for example, the first raw material may be or include limestone, which has a first concentration of calcium. The second raw material may be or include shale, which has a second concentration of silicon. The first and second raw materials are then mixed and reacted at a predetermined ratio to form reaction product that includes at least one synthetic formulation having the general formula (Ca_{w}Mₓ)ₐ(Si_{y}Me_{z})_{b}O_{c}, (Ca_{w}Mₓ)ₐ(Si_{y},Me_{z})_{b} (OH)_{d}, or (Ca_{w}Mₓ)ₐ (Si_{y},Me_{z})_{b} O_{c}(OH)_{d}.(H₂O)ₑ, wherein M may include one or more additional metals other than calcium that can react to form a carbonate and Me may include one or more elements other than silicon that can form an oxide during the carbonation reaction. The limestone and shale in this example may be mixed in a ratio a:b such that the resulting synthetic formulation can undergo a carbonation reaction as explained above. The resulting synthetic formulation may be, for example, wollastonite, CaSiO₃, having a 1:1 ratio of a:b. However, for synthetic formulation where M is mostly calcium and Me is mostly silicon, it is believed that a ratio of a:b between approximately 2.5:1 to approximately 0.167:1 may undergo a carbonation reaction because outside of this range there may not be a reduction in greenhouse gas emissions and the energy consumption or sufficient carbonation may not occur. For example, for a:b ratios greater than 2.5:1, the mixture would be M-rich, requiring more energy and release of more CO₂. Meanwhile for a:b ratios less than 0.167:1, the mixture would be Me-rich and sufficient carbonation may not occur.

In another example, the M in the first raw material includes a substantial concentration of calcium and magnesium. Thus, for example, the first raw material may be or include dolomite, which has a first concentration of calcium, and the synthetic formulation have the general formula (MgᵤCaᵥM_{w})ₐ (Si_{y},Me_{z})_{b}O_{c} or (MgᵤCaᵥM_{w})ₐ (Si_{y}Me_{z})_{b}(OH)_{d}, wherein M may include one or more additional metals other than calcium and magnesium that can react to form a carbonate and Me may include one or more elements other than silicon that can form an oxide during the carbonation reaction. In another example, the Me in the first raw material includes a substantial concentration of silicon and aluminum and the synthetic formulations have the general formula (CaᵥM_{w})ₐ(AlₓSi_{y},Me_{z})_{b}O_{c} or (CaᵥM_{w})ₐ(AlₓSi_{y},Me_{z})_{b}(OH)_{d}, (CaᵥM_{w})ₐ(AlₓSi_{y},Me_{z})_{b}O_{c}(OH)_{d}, or (CaᵥM_{w})ₐ(AlₓSi_{y},Me_{z})_{b}O_{c}(OH)_{d}.(H₂O)ₑ.

Compared to Portland cement, which has an a:b ratio of approximately 2.5:1, the exemplary synthetic formulations of the present invention result in reduced amounts of CO₂ generation and require less energy to form the synthetic formulation, which is discussed in more detail below. The reduction in the amounts of CO₂ generation and the requirement for less energy is achieved for several reasons. First, less raw materials, such as limestone for example, is used as compared to a similar amount of Portland Cement so there is less CaCO₃ to be converted. Also, because fewer raw materials are used there is a reduction in the heat (i.e. energy) necessary for breaking down the raw materials to undergo the carbonation reaction.

Other specific examples of carbonatable materials consistent with the above are described in U.S. Pat. No. 9,216,926 and U.S. provisional application No. 63/151,971, which are incorporated herein by reference in their entirety.

According to further embodiments, the carbonatable material comprises, consists essentially of, or consists of various calcium silicates. The molar ratio of elemental Ca to elemental Si in the composition is from about 0.8 to about 1.2. The composition is comprised of a blend of discrete, crystalline calcium silicate phases, selected from one or more of CS (wollastonite or pseudowollastonite), C3S2 (rankinite) and C2S (belite or larnite or bredigite), at about 30% or more by mass of the total phases. The calcium silicate compositions are characterized by having about 30% or less of metal oxides of Al, Fe and Mg by total oxide mass, and being suitable for carbonation with CO₂ at a temperature of about 30° C. to about 95° C., or about 30° C. to about 70° C., to form CaCO₃ with mass gain of about 10% or more. The calcium silicate composition may also include small quantities of C3S (alite, Ca₃SiO₅). The C2S phase present within the calcium silicate composition may exist in any α-Ca₂SiO₄, β-Ca₂SiO₄ or γ-Ca₂SiO₄ polymorph or combination thereof. The calcium silicate compositions may also include small quantities of residual CaO (lime) and SiO₂ (silica).

Calcium silicate compositions may contain amorphous (non-crystalline) calcium silicate phases in addition to the crystalline phases described above. The amorphous phase may additionally incorporate Al, Fe and Mg ions and other impurity ions present in the raw materials. Each of these crystalline and amorphous calcium silicate phases is suitable for carbonation with CO₂. The calcium silicate compositions may also include small quantities of residual CaO (lime) and SiO₂ (silica).

Each of these crystalline and amorphous calcium silicate phases is suitable for carbonation with CO₂. Upon complete carbonation, the amount of amorphous silicate obtained from each of the calcium silicate phases would be as follows: fully carbonated C3S would produce 16.7 wt % silica; fully carbonated C2S would produce 23.1 wt % silica; fully carbonated C3S2 would produce 28.6 wt % silica; and fully carbonated CS would produce 37.5 wt. % silica. The actual amount of silica produce from each calcium silicate phase will depend on the degree of carbonation of the underlying carbonatable material.

The calcium silicate compositions may also include quantities of inert phases such as melilite type minerals (melilite or gehlenite or akermanite) with the general formula (Ca,Na,K)₂ [(Mg,Fe²⁺,Fe³⁺,Al,Si)₃ O₇] and ferrite type minerals (ferrite or brownmillerite or C₄AF) with the general formula Ca₂ (Al,Fe³⁺)₂ O₅. In certain embodiments, the calcium silicate composition is comprised only of amorphous phases. In certain embodiments, the calcium silicate comprises only of crystalline phases. In certain embodiments, some of the calcium silicate composition exists in an amorphous phase and some exists in a crystalline phase.

Each of these calcium silicate phases is suitable for carbonation with CO₂. Hereafter, the discrete calcium silicate phases that are suitable for carbonation will be referred to as reactive phases. The reactive phases may be present in the composition in any suitable amount. In certain preferred embodiments, the reactive phases are present at about 50% or more by mass.

The various reactive phases may account for any suitable portions of the overall reactive phases. In certain preferred embodiments, the reactive phases of CS are present at about 10 to about 60 wt %; C3S2 in about 5 to 50 wt %; C2S in about 5 wt % to 60 wt %; C in about 0 wt % to 3 wt %.

In certain embodiments, the reactive phases comprise a calcium-silicate based amorphous phase, for example, at about 40% or more (e.g., about 45% or more, about 50% or more, about 55% or more, about 60% or more, about 65% or more, about 70% or more, about 75% or more, about 80% or more, about 85% or more, about 90% or more, about 95% or more) by mass of the total phases. It is noted that the amorphous phase may additionally incorporate impurity ions present in the raw materials.

It should be understood that, calcium silicate compositions, phases and methods disclosed herein can be adopted to use magnesium silicate phases in place of or in addition to calcium silicate phases. As used herein, the term “magnesium silicate” refers to naturally-occurring minerals or synthetic materials that are comprised of one or more of a groups of magnesium-silicon-containing compounds including, for example, Mg₂SiO₄ (also known as “forsterite”) and Mg₃Si₄O₁₀ (OH)₂ (also known as “talc”) and CaMgSiO₄ (also known as “monticellite”), each of which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

Another exemplary embodiment is directed to a method for forming cement or concrete, the method comprising: forming a carbonated supplementary cementitious material according to any of the exemplary method described herein; combining the carbonated supplementary cementitious material with a hydraulic cement composition to form a mixture, wherein the mixture comprises about 1% to about 99%, by weight, of the carbonated supplementary cementitious material, based on the total weight of solids in the mixture; and reacting the mixture with water to form the cement or concrete. The mixture may comprise about 20% to about 35% of the carbonated supplementary cementitious material by weight, based on the total weigh of solids in the mixture. The hydraulic cement may comprise one or more of ordinary Portland cement (OPC), calcium sulfoaluminate cement (CSA), belitic cement, or other calcium based hydraulic material. This method may further comprise adding an aggregate to the mixture, and the aggregate may be coarse and/or fine aggregates. The resulting cement or concrete may be suitable for various applications, including but not limited to foundations, road beds, sidewalks, architectural slabs, pavers, CMUs, wet cast tiles, segmented retaining walls, hollow core slabs, and other cast and pre-cast applications. The resulting cement or concrete may also be suitable for use in the preparation of a mortar appropriate for masonry applications.

Other specific examples of carbonatable calcium silicate materials consistent with the above are described in U.S. Pat. No. 10,173,927, which is incorporated herein by reference in its entirety. Other non-limiting examples of the carbonatable calcium silicate material and additional details of the supplementary cementitious material, and the incorporation thereof in ordinary Portland cement and the like, consistent with the above are described in U.S. provisional Application No. 63/151,971, which is incorporated herein by reference in its entirety.

Another exemplary embodiment is directed to a cementitious material including calcium silicate, calcium carbonate and amorphous silica. The amorphous silica content is present at about 5% to about 50%, about 8% to about 45%, about 8% to about 40%, about 9% to about 40%, about 10% to about 40%, about 20% to about 40%, by mass, and the amorphous silica is reactive with calcium hydroxide to form calcium silicate hydrate gel. The amorphous silica content can be equal to any integer value or values within any of these ranges, including the end-points of these ranges.

In accordance with exemplary embodiments of the present invention, the cement or concrete may comprise a plurality of bonding elements, each of the bonding elements comprising: a core (uncarbonated cement); a silica-rich first layer at least partially covering a peripheral portion of the core; and a calcium carbonate and/or magnesium carbonate-rich second layer at least partially covering a peripheral portion of the first layer. The silica-rich first layer may comprise amorphous silica. The amount of amorphous silica in the silica-rich layer may be higher than an amount of amorphous silica in a cement or concrete prepared without curing the mixture in a Ca(OH)₂ solution.

The silica-rich layer may further react with Ca(OH)₂ produced from ordinary Portland cement (OPC) hydration to form additional C—S—H (pozzolanic reaction), and the calcium carbonate from the supplementary cementitious material reacts with OPC to form monocarbonate.

The carbonatable material may comprise calcium silicate having a molar ratio of elemental Ca to elemental Si of about 0.5 to about 1.5, about 0.6 to about 1.4, about 0.7 to about 1.3, about 0.8 to about 1.2, about 0.9 to about 1.1, and the like. The molar ratio can be equal to any integer value or values within any of these ranges, including the end-points of these ranges.

The carbonatable material may comprise a blend of discrete, crystalline calcium silicate phases, selected from one or more of CS (wollastonite or pseudowollastonite), C3S2 (rankinite) and C2S (belite or larnite or bredigite), at about 20% or more, preferably about 25% or more, about 30% or more, about 35% or more, about 40% or more, about 45% or more, about 50% or more, about 55% or more, about 60% or more, about 65% or more, about 70% or more, about 75% or more, about 80% or more, about 85% or more, about 90% or more, and the like, and may be about 99% or less, about 98% or less, about 97% or less, about 96% or less, about 95% or less, and the like, by mass of the total phases. The blend of discrete, crystalline calcium silicate phases may also include about 50% or less, about 45% or less, about 40% or less, about 35% or less, about 30% or less, about 25% or less, about 20% or less, about 15% or less, about 10% or less, about 5% or less, and the like, of metal oxides of Al, Fe and Mg by total oxide mass. The amount of the blend of discrete, crystalline calcium silicate phases can be equal to any integer value or values within any of these ranges, including the end-points of these ranges. The carbonatable material may further comprise an amorphous calcium silicate phase.

According to various exemplary embodiments, the mixture of the carbonated supplementary cementitious material and the hydraulic cement composition comprises about 10% to about 70%, about 12% to about 65%, about 15% to about 60%, about 18% to about 55%, about 20% to about 50% of the carbonated supplementary cementitious material by weight, and the like, based on the total weight of solids in the mixture. The amount of the carbonated supplementary cementitious material can be equal to any integer value or values within any of these ranges, including the end-points of these ranges.

According to various exemplary embodiments, the curing may be carried out for about 5 days to about 60 days, about 6 days to about 60 days, about 7 days to about 60 days, about 10 days to about 50 days, about 15 days to about 45 days, about 20 days to about 30 days, and the like. In certain embodiments, the curing time may be about 90 days to about 180 days, about 95 days to about 170 days, about 100 days to about 160 days, about 105 days to about 150 days, about 110 to about 140 days, about 115 days to about 130 days, about 120 days, and the like. The curing time can be equal to any integer value or values within any of these ranges, including the end-points of these ranges.

In a comparative process that does not include curing with Ca(OH)₂, the carbonatable material is carbonated by bubbling a CO₂-containing gas through a slurry containing the carbonatable material and a small amount of water. In this comparative process, the gas comprising carbon dioxide may be obtained from a flue gas. However, the CO₂-containing gas is not limited thereto and any suitable source of gas containing carbon dioxide can be used. For example, a number of suppliers of industrial gases offer tanked carbon dioxide gas, compressed carbon dioxide gas and liquid carbon dioxide, in a variety of purities. Alternatively, the carbon dioxide can be recovered as a byproduct from any suitable industrial process. As used herein, a source of carbon dioxide from the byproduct of an industrial process will be generally referred to as “flue gas.” The flue gas may optionally be subject to further processing, such as purification, before being introduced into the slurry, semi-wet. By way of non-limiting examples, the carbon dioxide can be recovered from a cement plant, power plant, etc.

A flow rate of the CO₂-containing gas is from about 1 L/min to about 10 L/min, from about 1.5 L/min to about 9 L/min, from about 2 L/min to about 8 L/min, from about 2.5 L/min to about 7 L/min, from about 3 L/min to about 6 L/min, per kilogram of carbonatable material. The flow rate can be equal to any integer value or values within any of these ranges, including the end-points of these ranges.

The CO₂-containing gas may be flowed into the slurry for about 0.5 hours to about 24 hours, for about 1 hour to about 20 hours, for about 2 hours to about 15 hours, for about 5 hours to about 10 hours, for about 4 hours to about 6 hours, and the like. The time of flowing the gas can be equal to any integer value or values within any of these ranges, including the end-points of these ranges.

The CO₂-containing gas may be flowed over the carbonatable material at a temperature of about 1° C. to about 99° C., about 5° C. to about 90° C., about 10° C. to about 85° C., about 20° C. to about 80° C., about 30° C. to about 70° C., and the like. The temperature can be equal to any integer value or values within any of these ranges, including the end-points of these ranges.

Carbonation of Solidia Cement™ (an exemplary carbonatable material) produces more silica compared to carbonated OPC. This silica is important for a pozzolanic reaction, and the higher silica content of the carbonated Solidia Cement™ imparts certain advantageous properties compared to carbonated OPC.

Additionally, Solidia Cement™ contains low lime and high silica containing phases CS, C3S2, with a minor amount of C2S, in variable quantities. During the carbonation process about 60% to about 90%, about 65% to about 85%, about 70% to about 80%, and the like of the calcium silicate phases may be carbonated. The amount of the calcium silicate phases that are carbonated can be equal to any integer value or values within any of these ranges, including the end-points of these ranges.

The bonding elements produced from the comparative carbonation process (without Ca(OH)₂ curing) has an uncarbonated cement core, a silica-rich first layer at least partially covering a peripheral portion of the core, and a calcium carbonate and/or magnesium carbonate-rich second layer at least partially covering a peripheral portion of the first layer. These bonding elements improve mechanical and other properties associated with the cement or concrete.

Presence of fine calcium carbonate (calcite) accelerates the hydration of OPC providing nucleation sites. The calcium carbonate reacts with residual cement tricalcium aluminate (C3A) of OPC to produce monocarbonate potentially increasing the strength of the OPC. Upon Ca(OH)₂ curing, the silica layer present in a partially carbonated cement particle participates in a pozzolanic reaction by reacting with the Ca(OH)₂ produced during the hydration of OPC. This creates a unique bonding structure, which includes an unreacted Solidia Cement™ core, a silica-rich first layer, which undergoes a pozzolanic reaction (C—S—H), a calcium carbonate and/or magnesium carbonate-rich second layer at least partially covering a peripheral portion of the first layer and C—S—H from OPC hydration.

The principles of the present invention, as well as certain exemplary features and embodiments thereof, will now be described with reference to the drawings of certain embodiments which are intended to illustrate and not to limit the invention.

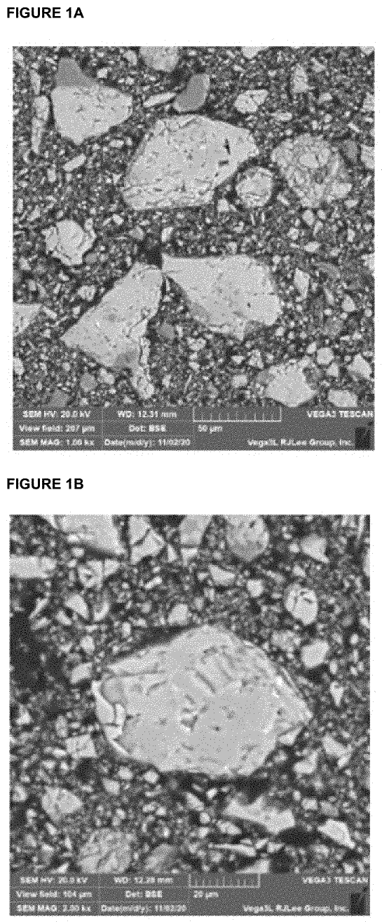

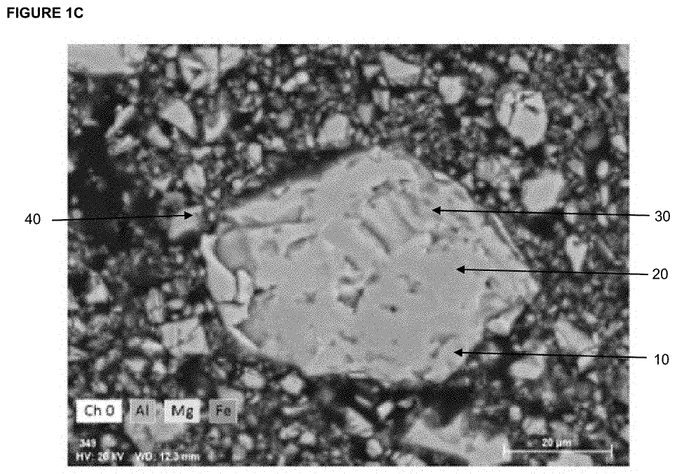

The microstructure of a carbonatable material, prior to any carbonation, is shown in FIGS. 1A to 1C. In more detail, FIG. 1C is an energy dispersive spectrometry (EDS) map showing distribution of a melilite phase (distribution of Fe, Mg, and Al) within the cement particles. As shown in FIG. 1C, Fe particles (20; green), Mg (30; yellow) and Al (40; teal) particles are dispersed among the cement particles (10; grey). The Mg and Al particles appear to overlap and seem to have a similar distribution pattern.

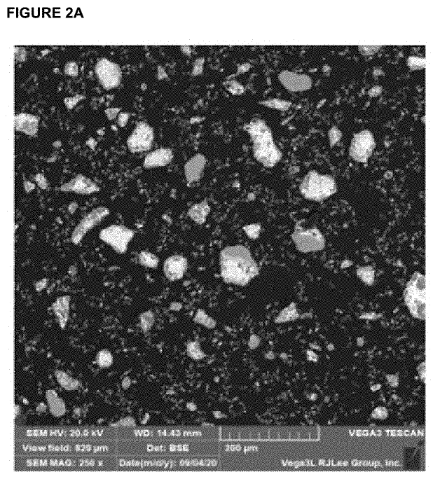

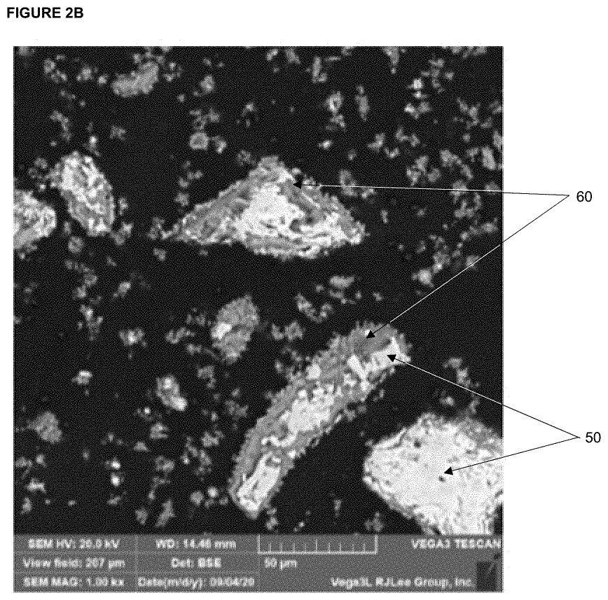

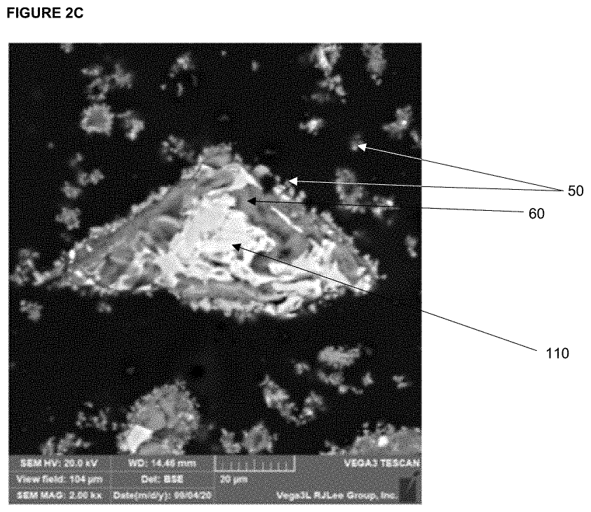

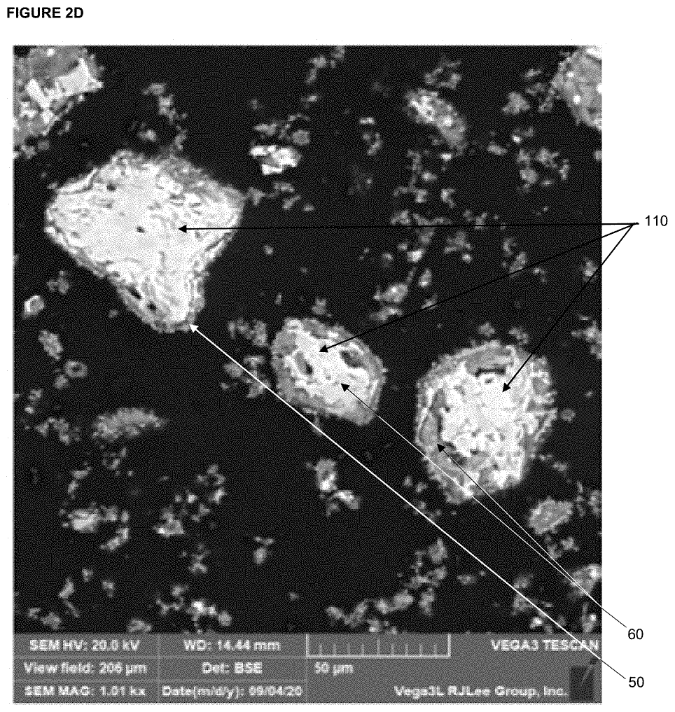

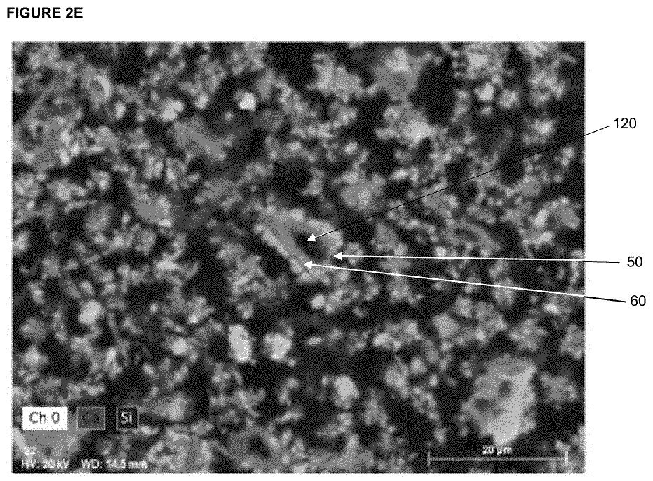

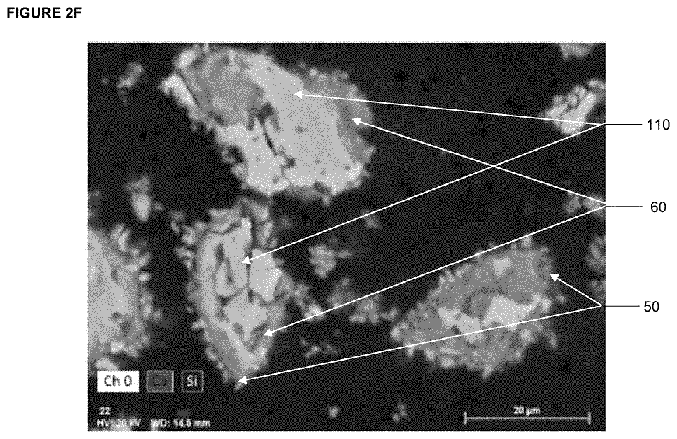

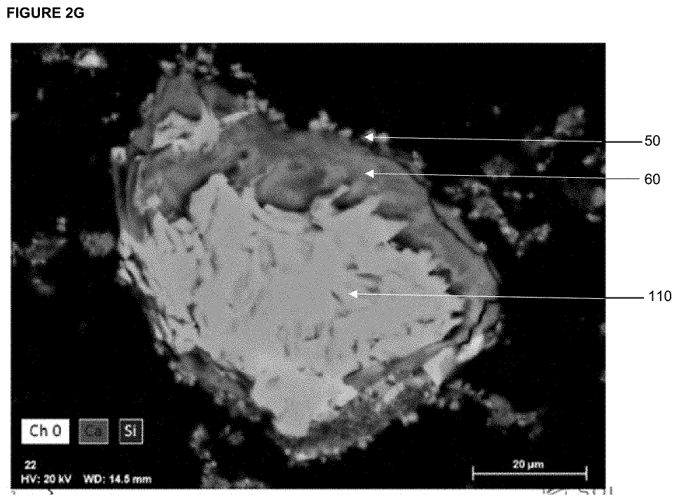

The microstructure of a carbonatable material after carbonation in a slurry, and subsequent drying, is shown in FIGS. 2A to 2G. The EDS maps of FIGS. 2E-2G show the distribution of Ca (50; red/pink) and Si (60; blue) particles, i.e., showing the silica and calcite layers. As shown in the EDS maps of FIGS. 2E, 2F and 2G, uncarbonated core of the cement particles (110; pink) are partially or fully surrounded by silica (1st layer) (60; blue) and calcite layers (50; pink/red). These structures are also surrounded by particulate calcite. FIG. 2E is an EDS map of carbonated cement showing calcium carbonate (50; pink/red) surrounding a layer of silica (60; blue) and an empty core (120). In FIG. 2E, the inner layer (60, blue) corresponds to silica gel of a completely carbonated particle surrounded by a calcite layer (50, pink). In comparison, in FIG. 2G, the red/pink core (110) corresponds to an uncarbonated cement particle surrounded by silica gel (60; blue) and calcite particles (50; pink).

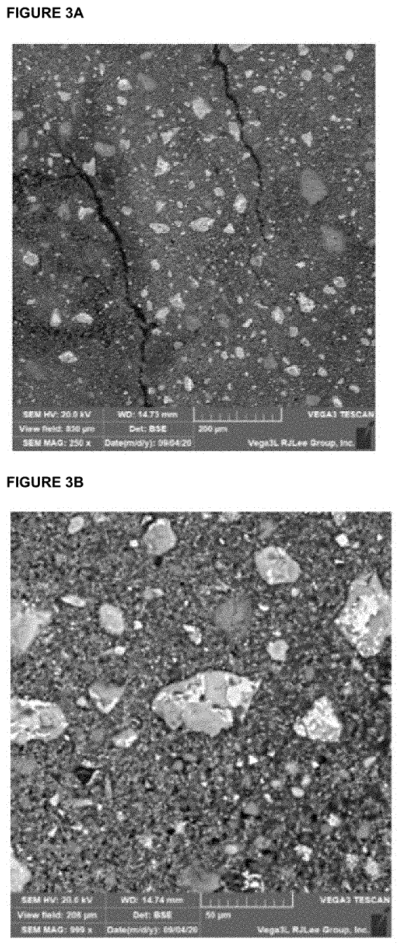

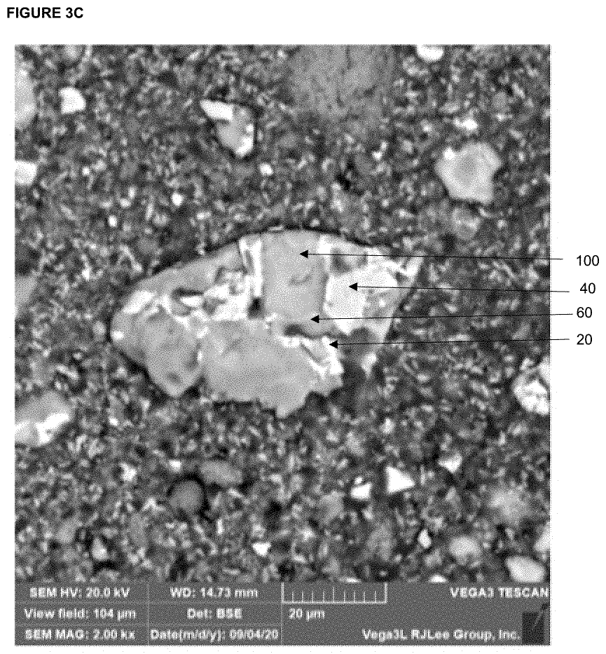

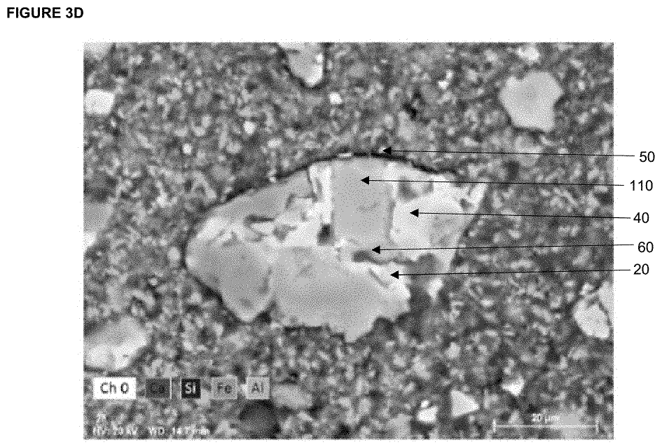

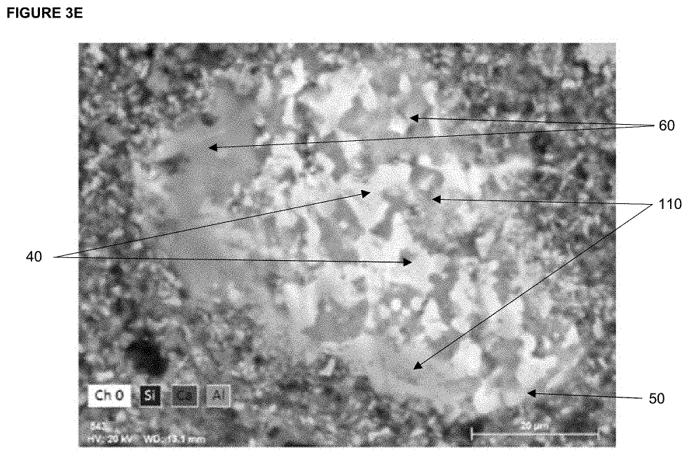

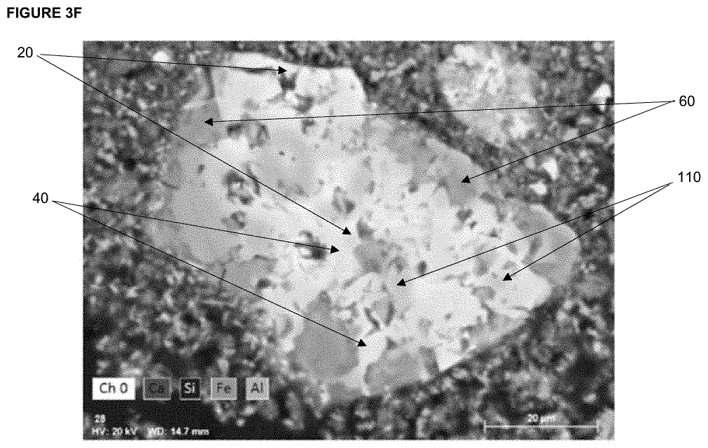

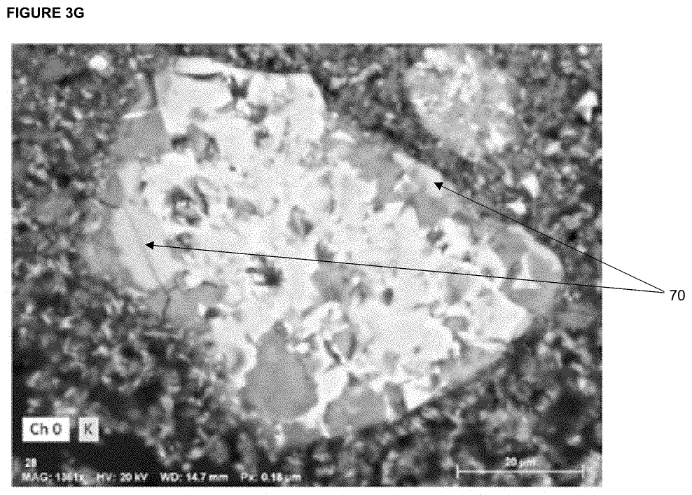

The microstructure of a carbonatable material after carbonation in a slurry, which includes Ca(OH)₂, is shown in FIGS. 3A to 3G. The distribution of Si (60; blue), Ca (50; red/pink), Al (40; teal) and Fe (20; green) in the cement particles are also shown in the EDS maps of FIGS. 3D and 3F, Si (60; blue), Ca (50; red/pink) and Al (440; green), and the distribution of K (70; yellow) is shown in the EDS map of FIG. 3G. As shown, for example, in FIG. 3F, the silica layer is formed as an outer layer, with the remaining materials dispersed in the core.

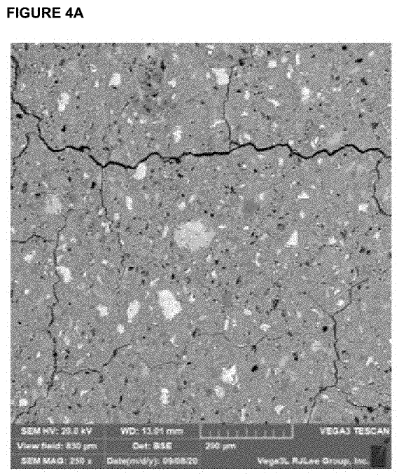

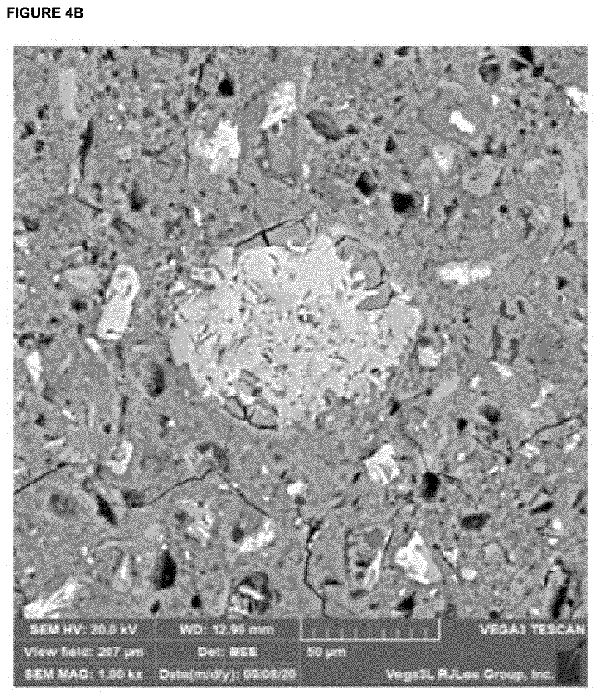

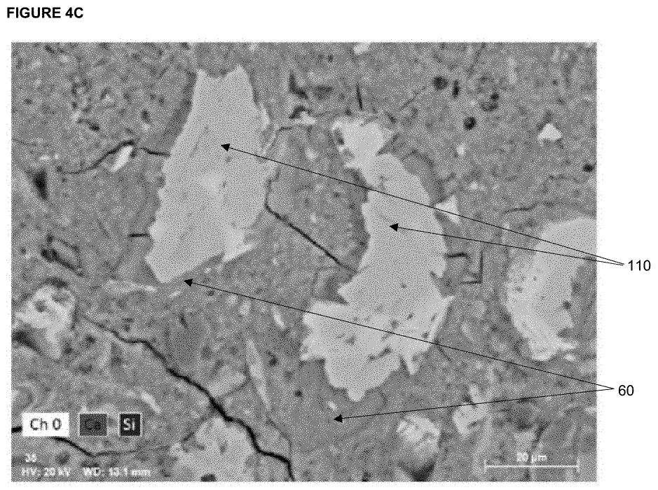

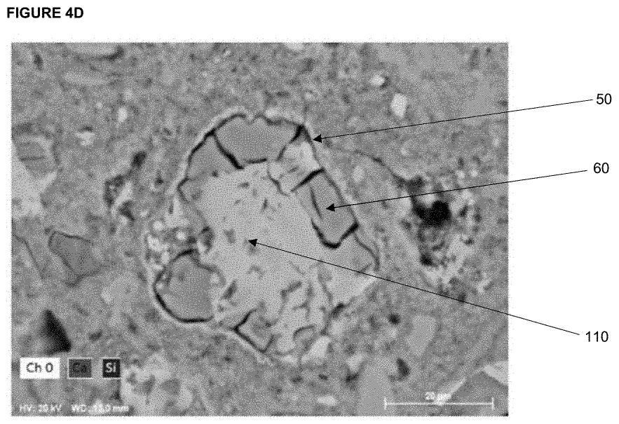

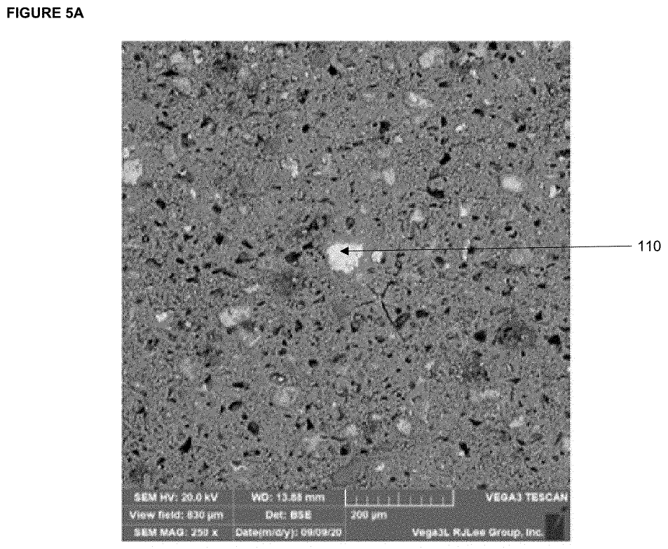

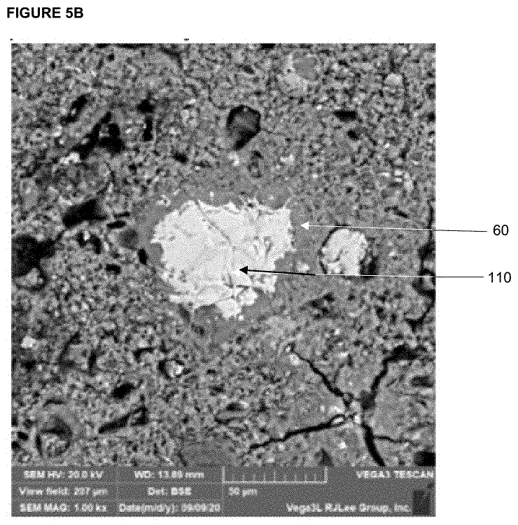

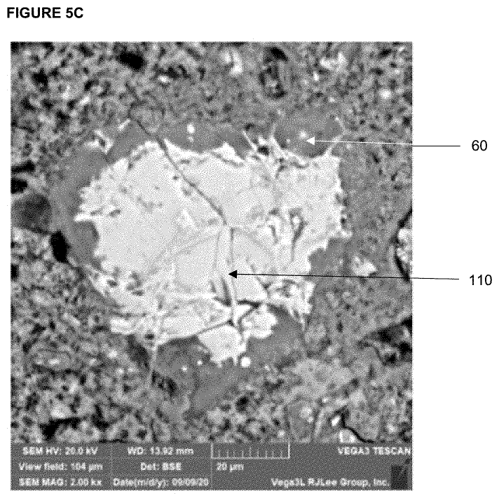

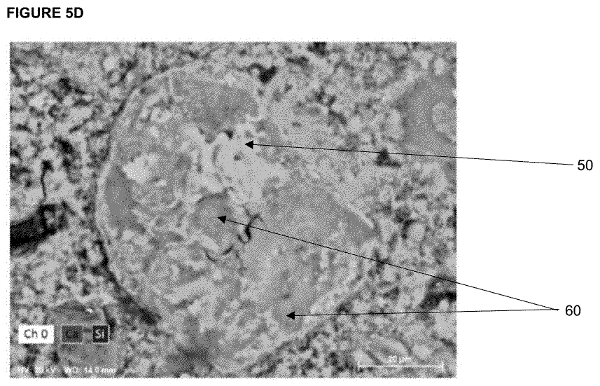

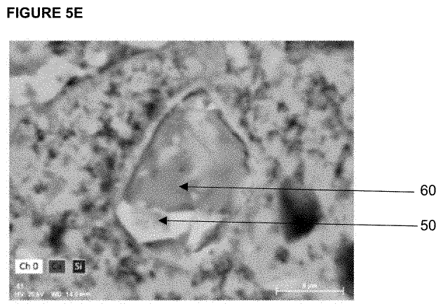

The microstructure of a mixture of 20% slurry of carbonatable material and 80% ordinary Portland cement after carbonation and curing in lime water (Ca(OH)₂) for 28 days is shown in FIGS. 4A to 4D; and the microstructure of a mixture of 50% slurry of carbonatable material and 50% ordinary Portland cement after carbonation and curing in lime water (Ca(OH)₂) for 28 days is shown in FIGS. 5A to 5E. FIGS. 4C, 4D, 5D and 5E are EDS maps showing distribution of Ca (50; red/pink) and Si (60; blue) in the cement particles.

The principles of the present invention, as well as certain exemplary features and embodiments thereof, will now be described by reference to the following non-limiting examples.

As various changes could be made in the above methods and compositions without departing from the scope of the invention, it is intended that all matter contained in the above description shall be interpreted as illustrative and not in a limiting sense. Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

We claim:

1. A method for forming cement or concrete, the method comprising:
combining a carbonated supplementary cementitious material with a hydraulic cement composition to form a mixture, wherein the mixture comprises about 1% to about 99%, by weight, of the carbonated supplementary cementitious material, based on the total weight of solids in the mixture;
curing the mixture in a Ca(OH)₂ solution;
reacting the mixture with water to form the cement or concrete;
wherein the cement or concrete may further include a hydration product selected from Ca(OH)₂ (portlandite), Ca₆Al₂(SO₄)₃(OH)₁₂.26H₂O (ettringite), Ca₄Al₂(SO₄)(OH)₁₂.6H₂O (monosulfate), 3CaO.Al₂O₃.CaCO₃.11H₂O (monocarbonate), calcium silicate hydrate (C—S—H) gel, and hydrated amorphous mellilites.

2. The method of claim 1, wherein the carbonated supplementary cementitious material is prepared by flowing a gas comprising carbon dioxide into a carbonatable material for about 0.01 hours to about 72 hours and maintaining a temperature of about 1° C. to about 99° C.

3. The method of claim 1, wherein the carbonatable material includes at least one synthetic formulation having the general formula MₐMe_{b}O_{c}, MₐMe_{b}(OH)_{d}, MₐMe_{b}O_{c}(OH)_{d} or MₐMe_{b}O_{c} (OH)_{d}.(H₂O)ₑ, wherein M is at least one metal that can react to form a carbonate and Me is at least one element that can form an oxide during the carbonation reaction.

4. The method of claim 3, wherein M is calcium and/or magnesium.

5. The method of claim 3, wherein Me is silicon, titanium, aluminum, phosphorus, vanadium, tungsten, molybdenum, gallium, manganese, zirconium, germanium, copper, niobium, cobalt, lead, iron, indium, arsenic, sulfur and/or tantalum.

6. The method of claim 5, wherein Me is silicon.

7. The method of claim 3, wherein a ratio of a:b is about 2.5:1 to about 0.167:1, c is 3 or greater, d is 1 or greater, e is 0 or greater.

8. The method of claim 1, wherein the cement or concrete comprises a plurality of bonding elements, each of the bonding elements comprising:
a core (uncarbonated cement or concrete);
a silica-rich first layer at least partially covering a peripheral portion of the core;
a calcium carbonate and/or magnesium carbonate-rich second layer at least partially covering a peripheral portion of the first layer, and
a layer of C—S—H formed by a reaction of the silica-rich layer with Ca(OH)₂.

9. The method of claim 8, wherein the silica-rich first layer comprises amorphous silica.

10. The method of claim 8, wherein an amount of amorphous silica in the silica-rich layer is higher than an amount of amorphous silica in a cement or concrete prepared without curing the mixture in a Ca(OH)₂ solution.

11. The method of claim 8, wherein the Ca(OH)₂ is produced from ordinary Portland cement (OPC) hydration.

12. The method of claim 1, wherein calcium carbonate from the supplementary cementitious material reacts with OPC to form 3CaO.Al₂O₃.CaCO₃.11H₂O (monocarbonate).

13. The method of claim 1, wherein the carbonatable material comprises calcium silicate having a molar ratio of elemental Ca to elemental Si of about 0.8 to about 1.2.

14. The method of claim 13, wherein the carbonatable material comprises a blend of discrete, crystalline calcium silicate phases, selected from one or more of CS (wollastonite or pseudowollastonite), C₃S₂ (rankinite) and C₂S (belite or larnite or bredigite), at about 30% or more by mass of the total phases, and about 30% or less of metal oxides of Al, Fe and Mg by total oxide mass.

15. The method of claim 1, wherein the carbonatable material further comprises an amorphous calcium silicate phase.

16. The method of claim 1, wherein the curing is carried out for about 7 days to about 60 days.

17. The method of claim 1, wherein the mixture comprises about 10% to about 70% of the carbonated supplementary cementitious material by weight, based on the total weight of solids in the mixture.

18. The method of claim 1, wherein the hydraulic cement comprises one or more of ordinary Portland cement, calcium sulfoaluminate cement, belitic cement, or other calcium based hydraulic material.

19. A cementitious material comprising calcium silicate, calcium carbonate and amorphous silica;
wherein the amorphous silica content is present at about 5% to about 50% by mass, and
wherein the amorphous silica is reactive with calcium hydroxide to form calcium silicate hydrate gel (C—S—H).

20. A cement or concrete material comprising a plurality of bonding elements, wherein each of the bonding elements comprises:
a. a core (uncarbonated cement or concrete);
b. a silica-rich first layer at least partially covering a peripheral portion of the core;
c. a calcium carbonate and/or magnesium carbonate-rich second layer at least partially covering a peripheral portion of the first layer; and
d. a layer of C—S—H formed by a reaction of the silica-rich layer with Ca(OH)₂,
wherein the cement or concrete material is prepared from a method comprising:
combining a carbonated supplementary cementitious material with a hydraulic cement composition to form a mixture, wherein the mixture comprises about 1% to about 99%, by weight, of the carbonated supplementary cementitious material, based on the total weight of solids in the mixture;
curing the mixture in a Ca(OH)₂ solution; and
reacting the mixture with water to form the cement or concrete,
wherein the cement or concrete may further include a hydration product selected from Ca(OH)₂ (portlandite), Ca₆Al₂(SO₄)₃(OH)₁₂.26H₂O (ettringite), Ca₄Al₂(SO₄)(OH)₁₂.6H₂O (monosulfate), 3CaO.Al₂O₃.CaCO₃.11H₂O (monocarbonate), calcium silicate hydrate (C—S—H) gel, and hydrated amorphous mellilites.
